(19) United States
(12) Patent Application Publication
(10) Pub. No.: US 2024/0159183 A1
(43) Pub. Date: May 16, 2024

(54) V -TYPE ENGINE, OUTBOARD MOTOR, AND WATERCRAFT

(71) Applicant: HONDA MOTOR CO., LTD., Tokyo (JP)

(72) Inventors: Shohei Kono, Wako-shi, Saitama (JP); Hirosuke Niwa, Wako-shi, Saitama (JP); Hayate Araki, Wako-shi, Saitama (JP)

(21) Appl. No.: 18/550,508

(22) PCT Filed: Mar. 19, 2021
(86) PCT No.: PCT/JP2021/011464

§ 371 Date: Sep. 14, 2023

(51) Int. Cl. F02B 75/22; F02B 61/04

(52) U.S. Cl. CPC F02B 75/22; F02B 61/045

(57) ABSTRACT

An outboard motor in which an exhaust pipe arrangement is easily performed and the center of gravity can be lowered. Cylinders where pistons operate are arranged in a V-shape and a crankshaft driven by driving of the pistons is disposed vertically, and upper exhaust pipes (exhaust pipes) communicating with exhaust openings in the respective banks of a cylinder head and a catalyst holder that is provided in a position, which corresponds to a lower side of the cylinder, of the upper exhaust pipe and that holds a catalyst are included. In this manner, arrangement of the upper exhaust pipe and a lower exhaust pipe is easily performed while the catalytic effect is maintained and the center of gravity can be lowered, and also, the size and weight of the V-type engine can be reduced.

### TECHNICAL FIELD

The present invention relates to a V-type engine, an outboard motor, and a watercraft.

### BACKGROUND ART

Conventionally, purification of engine exhaust gas has been an important issue, but in general-purpose machines requiring compact engine periphery, it is difficult to install equipment for such purpose in a finite space, and thus, there have been a few such implementation examples. However, on the back of recent increasing environmental concerns, research on installation of exhaust purification equipment in general-purpose machines has actively been conducted. Conventionally, a technique of such a V-type engine has been disclosed in which it is configured so as to include a catalyst inside an exhaust pipe and above the center line of an exhaust port of a cylinder at the lowest in a right bank and a left bank in an upper portion of the exhaust pipe (see, for example, patent literature 1).

### CITATION LIST

### Patent Literature

### Patent Literature 1

Japanese Patent Laid-Open No. 2015-200297

### SUMMARY OF INVENTION

### Technical Problem

However, since prior art is configured to arrange a catalyst on a lateral side of a cylinder, arrangement of an exhaust pipe from an exhaust opening of an engine to the catalyst is burdensome, and a problem of a higher center of gravity of an outboard motor could arise due to the catalyst positioned on an upper side.

The present invention has been made in view of the aforementioned circumstances, and has an object to provide a V-type engine, an outboard motor, and a watercraft in which exhaust pipe arrangement is easily performed while a catalytic effect is maintained by arranging a catalyst immediately near an exhaust opening and the center of gravity can be lowered, and also, the size and weight can be reduced.

### Solution to Problem

In order to achieve the aforementioned object, a V-type engine according to the present invention, in which cylinders where pistons operate are arranged in a V-shape and a crankshaft driven by driving of the pistons is disposed vertically, includes exhaust pipes communicating with exhaust openings in the respective banks of a cylinder head and a catalyst holder that is provided in a position, which corresponds to a lower side of the cylinder head, of the exhaust pipe and that holds a catalyst.

### Advantageous Effects of Invention

According to the present invention, since a catalyst is provided in a position, which corresponds to a lower side of a cylinder head of a V-type engine, of an exhaust pipe, exhaust pipe arrangement is easily performed while a catalytic effect is maintained and the center of gravity can be lowered, and also, the size and weight of the engine can be reduced.

### BRIEF DESCRIPTION OF DRAWINGS

FIG. 1 is a longitudinal cross-sectional view illustrating an embodiment of a V-type engine used in an outboard motor according to the present invention.

FIG. 2 is a lateral cross-sectional view of the V-type engine of a first embodiment.

FIG. 3 is a schematic configurational view illustrating an exhaust structure of the first embodiment.

FIG. 4 is a schematic configurational view illustrating a catalyst holder of the first embodiment.

FIG. 5 is a schematic configurational view illustrating the catalyst holder of a second embodiment.

### DESCRIPTION OF EMBODIMENTS

Hereinafter, embodiments of the present invention will be described with reference to the drawings.

### First Embodiment

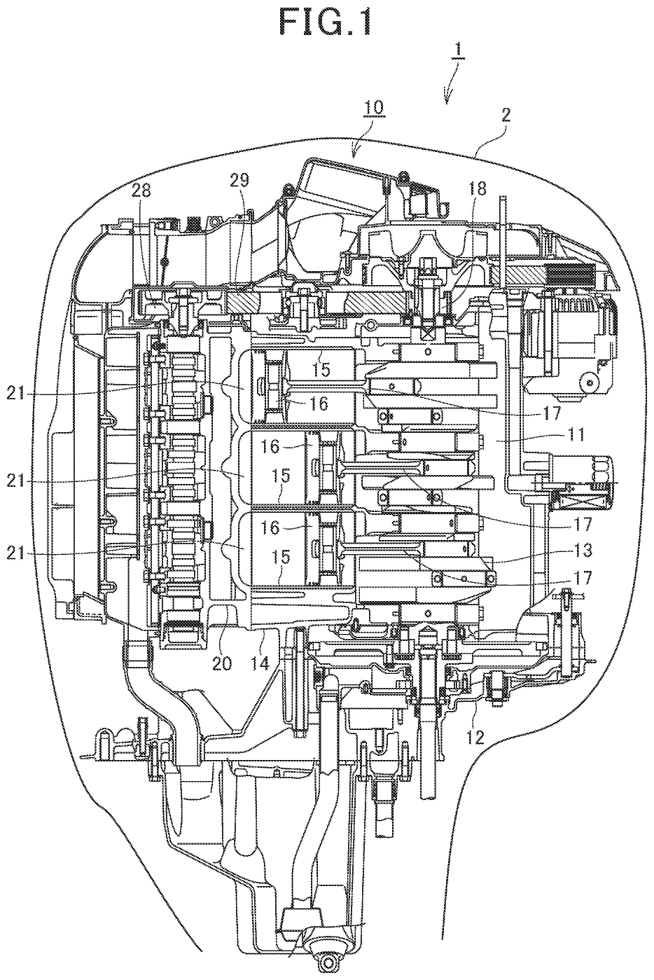

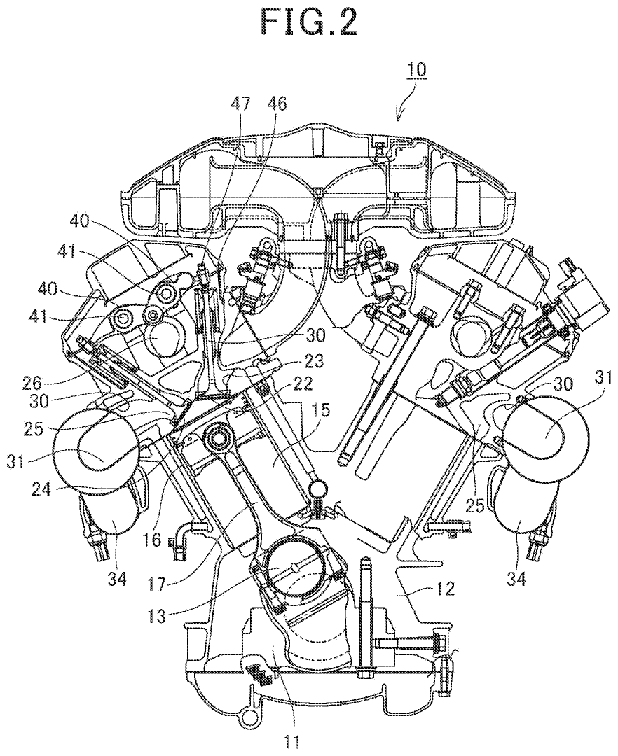

First, a V-type engine used in an outboard motor of the present invention will be described with reference to FIG. 1 and FIG. 2.

FIG. 1 is a longitudinal cross-sectional view illustrating an embodiment of a V-type engine. FIG. 2 is a lateral cross-sectional view of the V-type engine of the present embodiment.

As illustrated in FIG. 1 and FIG. 2, a V-type engine 10 of an outboard motor 1 is a V-type six-cylinder, water-cooled, four-stroke engine with three cylinders 15 arranged in a V-shape.

The V-type engine 10 includes a crankcase 12 that forms a crank chamber 11. A crankshaft 13 is rotatably supported in the crankcase 12.

In each cylinder 15 of a cylinder block 14, a piston 16 is housed reciprocatably and each piston 16 is coupled to the crankshaft 13 via a connecting rod 17.

The V-type engine 10 is housed in a casing 2 of the outboard motor 1. The crankshaft 13 is configured so as to be coupled to a screw via a driving power transmission mechanism (not shown), so that the screw can be rotationally driven by the rotation of the crankshaft 13.

A cylinder head 20 is provided, for each cylinder 15, with a combustion chamber 21 formed facing the piston 16, an intake port 23 that opens in the combustion chamber 21 and that is opened and closed by a pair of intake valves 22, and an exhaust port 25 that is opened and closed by a pair of exhaust valves 24.

The intake valves 22 and the exhaust valves 24 are driven to open and close by a cam 27 provided in a camshaft 26 that is rotatably pivotably supported in the cylinder head 20 and a rocker arm 40 that abuts on the cam 27.

The camshaft 26 is provided, in a right end portion, with a cam sprocket 28, and a timing belt 29 is stretched over between a drive sprocket 18 fitted near a right end portion of the crankshaft 13 and the cam sprocket 28.

In this manner, the intake valves 22 and the exhaust valves 24 are driven to open and close in synchronization with the rotation of the crankshaft 13.

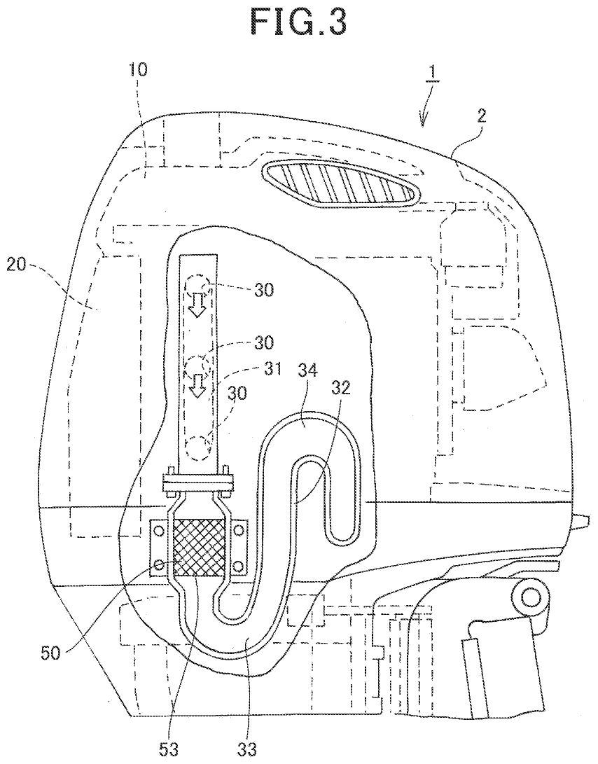

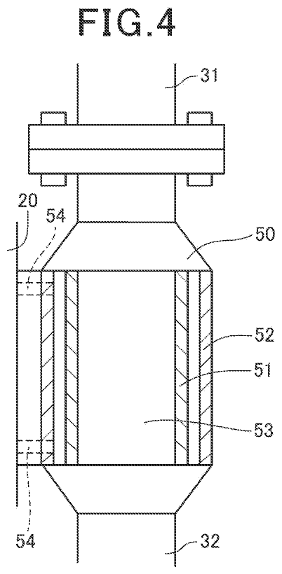

FIG. 3 is a schematic configurational view illustrating an exhaust structure of the V-type engine 10. FIG. 4 is a schematic configurational view illustrating a catalyst holder of the present embodiment.

As illustrated in FIG. 3, the V-type engine 10 is housed in the casing 2 of the outboard motor 1.

The V-type engine 10 includes upper exhaust pipes 31 each communicating with exhaust openings 30 of three cylinders in two banks in a V-shape. The upper exhaust pipes 31 are each arranged so as to extend in an up-down direction on the opposite sides of the V-type engine 10.

As illustrated in FIG. 3 and FIG. 4, a catalyst holder 50 is connected to a lower end portion of each of the upper exhaust pipes 31. The catalyst holder 50 is provided integrally with the cylinder head 20 of the V-type engine 10. The catalyst holder 50 includes an inner tube 51 and an outer tube 52 disposed on an outer side of the inner tube 51.

In the present embodiment, the catalyst holder is provided near the exhaust opening 30 at the lowest in each bank of the V-type engine, more preferably, immediately below the exhaust opening 30 at the lowest in each bank.

A catalyst 53 is housed on an inner side of the inner tube 51. The catalyst 53 is a three-way catalyst that removes hazardous components in the exhaust gas, such as hydrocarbon (HC), carbon monoxide (CO), and nitrogen oxides (NOx), through oxidation and reduction reaction, and has, for example, a honeycomb catalyst structure in which a porous honeycomb structure body is coated with catalyst components, such as platinum, palladium, and rhodium. Note that the structure is not limited to the honeycomb catalyst structure, but may be of a simple type, such as a plate catalyst structure in which catalyst components are carried on a plate material.

The configuration is made such that part of cooling water to be delivered to the V-type engine 10 is guided between the inner tube 51 and the outer tube 52.

That is, a cooling water channel (not shown) is provided inside the cylinder head 20 of the V-type engine 10, and two pieces of cooling water piping 54 communicating with the cooling water channel are connected to the cylinder head 20.

Each piece of cooling water piping 54 communicates with a space between the outer tube 52 and inner tube 51.

In the present embodiment, the cooling water passes from the cylinder head 20 through the cooling water piping 54 that is positioned on a lower side to flow into the space between the outer tube 52 and the inner tube 51 so as to cool the catalyst 53, and then returns to the cylinder head 20 through the cooling water piping 54 positioned on an upper side.

A lower exhaust pipe 32 is connected to a lower side of the catalyst holder 50. The exhaust pipe of the present invention is configured with the upper exhaust pipe 31 and the lower exhaust pipe 32.

The lower exhaust pipe 32 includes midway an upper side folded-back portion 33 formed in an upward curve and a lower side folded-back portion 34 formed in a curve downward from the upper side folded-back portion 33.

A tip end portion of the lower exhaust pipe 32 communicates with an exhaust passage provided inside the casing 2. The exhaust passage communicates with water via a center portion of the screw (not shown).

In the present embodiment, an upper end portion of the lower side folded-back portion 34 is arranged so as to be positioned above the catalyst holder 50. In this manner, even when water enters from the lower exhaust pipe 32 via the exhaust passage, delivery of the water from the lower side folded-back portion 34 to the catalyst side can be restricted.

Next, the function of the present embodiment will be described.

In the present embodiment, the V-type engine 10 is driven, thereby transmitting the driving force of the V-type engine 10 to a screw shaft (not shown) via the crankshaft 13 to thus rotate the screw so as to move a watercraft forward or backward.

The exhaust gas discharged from the cylinder head 20 of the V-type engine 10 is delivered to the upper exhaust pipe 31 through the exhaust openings 30.

Then, the hazardous components in the exhaust gas delivered to the upper exhaust pipe 31 are removed in the catalyst holder 50 by the catalyst 53, which sufficiently exhibits the catalytic effect through oxidation and reduction reaction, and the exhaust gas is discharged into the water through a screw portion via the lower exhaust pipe 32.

Here, it is said that the catalyst 53 exhibits the maximum efficiency normally at a temperature around 400° C., but in the present embodiment, the catalyst holder 50 is provided in a position, which corresponds to a lower side of the cylinder 15, of the upper exhaust pipe 31 and the lower exhaust pipe 32, and the catalyst 53 is arranged in the exhaust openings 30 that have a relatively high temperature, so that the catalytic efficiency can be improved. Further, in the case of the V-type engine 10, since the site where the catalyst is arranged is an unused site, arrangement of the lower exhaust pipe 32 on the downstream side of catalyst can be performed without waste, and the V-type engine 10 can be reduced in size and weight as a whole.

In this case, in order to favorably perform oxidation and reduction reaction of the catalyst 53, the catalyst 53 needs to be maintained at a predetermined temperature. In the present embodiment, since cooling water is supplied between the inner tube 51 and the outer tube 52 of the catalyst holder 50 via the cooling water piping 54 so as to maintain the temperature of the catalyst holder 50 at a predetermined temperature, the temperature of the catalyst 53 can be adjusted to be a predetermined temperature.

Note that in the form of finished equipment, it is natural to select a cooling method, and for example, for a riding lawn mower or a riding snow blower, indirect cooling as in a passenger vehicle may be adopted, and for the outboard motor 1, a direct cooling method of directly taking in cooling water from water may be adopted. In addition, in the case of the outboard motor 1, when the cooling capacity is insufficient, the cooling capacity may be reinforced with a pump or the like that is driven by an electric motor, or indirect cooling for cooling the catalyst or further, a direct cooling system for cooling the catalyst may be separately provided.

In the indirect cooling, a cooling unit is separately installed and the catalyst holder is cooled by the cooling unit, and it is preferable to provide, as the cooling unit, those having a radiator, for example, which can more properly control the temperature adjustment of the catalyst to thus contribute to exhibiting the capacity and the durability of the catalyst.

Further, the direct cooling system separately supplies cooling water from water to the catalyst holder and releases the cooling water into the water from the catalyst holder, the direct cooling system exhibiting sufficient effects as with the indirect cooling in which the cooling unit is installed, only with the addition of simple equipment.

Furthermore, since the upper side folded-back portion 33 and the lower side folded-back portion 34 are provided in the lower exhaust pipe 32, in a case where the direct cooling method in which cooling water is taken in from water as in the outboard motor 1 is adopted, even when the water enters from the screw via the lower exhaust pipe 32, delivery of the water from the lower side folded-back portion 34 to the catalyst 53 side can be restricted. In this manner, the water does not reach the catalyst holder 50, so that a waterproof measure can be sufficiently taken.

Moreover, in a case where the waterproof measure is not required as in a riding lawn mower, a riding snow blower, and the like, it is only necessary to arrange the exhaust pipe 30 on an engine mount directly from the catalyst holder 50 so as to communicate with the exhaust passage provided inside the casing 2.

Further, when an upper end of the lower side folded-back portion 34 formed in a curve is above the catalyst 53, the waterproof effect increases. When the lower side folded-back portion 34 is on a further upper side, the waterproof effect can be further expected, but the exhaust openings 30 takes up the unused site of the V-type engine 10, and therefore, how far the exhaust openings 30 is extended upward only needs to be appropriately selected by setting designing conditions for the engine.

Furthermore, when the lower exhaust pipe 32 on a downstream side of the catalyst holder 50 is arranged on the engine mount and communicates with the exhaust passage provided inside the casing 2, the layout of the exhaust system can be realized without waste.

As described above, in the present embodiment, the cylinders 15 where the pistons 16 operate are arranged in a V-shape and the crankshaft 13 driven by driving of the pistons 16 is disposed vertically, and the upper exhaust pipes 31 (exhaust pipes) communicating with the exhaust openings 30 in the respective banks of the cylinder head 20 and the catalyst holder 50 that is provided in the position, which corresponds to the lower side of the cylinder head 20, of the upper exhaust pipe 31 and that holds the catalyst 53 are included.

In this manner, since the catalyst 53 is provided in the position corresponding to the lower side of the cylinder head 20 of the V-type engine 10, the arrangement of the upper exhaust pipe 31 and the lower exhaust pipe 32 is easily performed while the catalytic effect is maintained and the center of gravity can be lowered, and also, the size and weight of the V-type engine 10 can be reduced. Further, the catalyst holder 50 is provided in the position, which corresponds to the lower side of the cylinder head 20, of the upper exhaust pipe 31 and the lower exhaust pipe 32, and the catalyst 53 is arranged in the exhaust openings 30 that have a relatively high temperature, so that the catalytic efficiency can be improved. Furthermore, in the case of the V-type engine 10, since the site where the catalyst is arranged is the unused site, the arrangement of the lower exhaust pipe 32 on the downstream side of catalyst can be performed without waste, and the V-type engine 10 can be reduced in size and weight as a whole.

Further, in the present embodiment, the catalyst holder 50 is provided on a lower side of the exhaust opening 30 positioned at the lowest of the exhaust openings 30.

In this manner, since the catalyst holder 50 is provided on the lower side of the exhaust opening 30 positioned at the lowest of the exhaust openings 30, the arrangement of the upper exhaust pipe 31 and the lower exhaust pipe 32 is easily performed and the center of gravity can be lowered.

Furthermore, in the present embodiment, the lower exhaust pipe 32 (exhaust pipe) includes the upper side folded-back portion 33 formed in an upward curve on the downstream side of the catalyst 53 and the lower side folded-back portion 34 formed in a curve downward from the upper side folded-back portion 33.

In this manner, even when water enters from the exhaust pipe, delivery of the water from the lower side folded-back portion 34 to the catalyst 53 side can be restricted and the water does not reach the catalyst holder 50, so that the waterproof measure can be sufficiently taken. Further, by covering the catalyst holder 50, the upper exhaust pipe 31, and the lower exhaust pipe 32 with metal or a fiber-reinforced resin to restrict the heat release, the temperature inside an engine case and an engine room can be controlled to a certain temperature or lower, which is effective in controlling an intake temperature to a certain temperature or lower and improving the durability of the engine.

In addition, in the present embodiment, the lower side folded-back portion 34 is positioned above the catalyst holder 50.

In this manner, even when water enters from the lower exhaust pipe 32, delivery of the water from the lower side folded-back portion 34 to the catalyst 53 side can be restricted and the water does not reach the catalyst holder 50, so that the waterproof measure can be sufficiently taken.

Further, in the present embodiment, the cooling water piping 54 where part of the cooling water for the V-type engine 10 is delivered is connected to the catalyst holder 50.

In this manner, by supplying the cooling water to the catalyst holder 50 via the cooling water piping 54, the temperature of the catalyst holder 50 can be adjusted to a predetermined temperature, with few changes to the cooling system of the V-type engine. Therefore, by maintaining the catalyst 53 at a predetermined temperature, oxidation and reduction reaction of the catalyst 53 can be favorably performed.

### Second Embodiment

Next, a second embodiment of the present invention will be described.

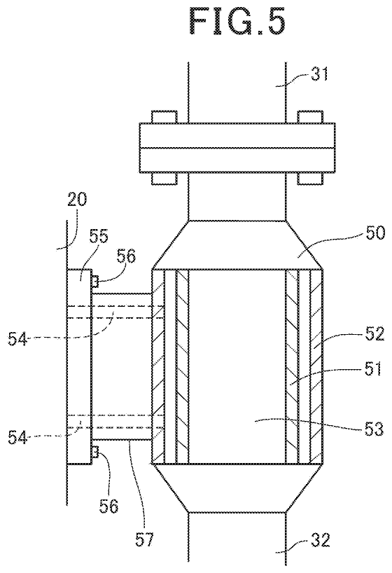

FIG. 5 is a schematic view illustrating a second embodiment of the present invention.

As illustrated in FIG. 5, a gasket 55 is attached to the cylinder head 20 with a screw 56 and the gasket 55 is integrally provided with an attaching jig 57.

The catalyst holder 50 is attached to the attaching jig 57. The catalyst holder 50 may be fixed to the attaching jig 57 with a screw or the like, or through welding or the like.

That is, in the present embodiment, the catalyst holder 50 is attached to the cylinder head 20 via the attaching jig 57.

In the present embodiment, the cooling water piping 54 is provided inside the attaching jig 57. The cooling water piping 54 communicates with the space between the inner tube 51 and the outer tube 52 of the catalyst holder 50.

In this manner, with a space provided between the cylinder block 14 or the cylinder head 20 of the V-type engine 10 and the catalyst holder 50, a fuel tube, a harness, or the like can be arranged, and a through hole is further provided in the attaching jig 57 and this portion may be a passage for the aforementioned article.

Since the other components are the same as those of the first embodiment, the same portions are assigned the same reference signs and the descriptions are omitted.

In the present embodiment, as with the first embodiment, cooling water is supplied to the catalyst holder 50 through the cooling water piping 54 provided in the attaching jig 57 so that the temperature of the catalyst holder 50 can be adjusted to a predetermined temperature. Therefore, by maintaining the catalyst 53 at a predetermined temperature, oxidation and reduction reaction of the catalyst 53 can be favorably performed.

Note that in the aforementioned embodiments, the present invention has been described, but the present invention is not limited to the aforementioned embodiments, and change, substitution, addition, omission, and the like in various ways are available as needed.

Further, the present invention does not limit the finished equipment as long as it is the V-type engine in which the crankshaft is disposed vertically, and is applicable to, for example, a riding lawn mower, a grass mower, a riding snow blower, or an outdoor motor.

[Configurations Supported by the Aforementioned Embodiments]

The aforementioned embodiments support the following configurations.

(Configuration 1) A V-type engine in which cylinders where pistons operate are arranged in a V-shape and a crankshaft driven by driving of the pistons is disposed vertically, the V-type engine including: exhaust pipes communicating with exhaust openings in respective banks of a cylinder head; and a catalyst holder that is provided in a position, which corresponds to a lower side of the cylinder head, of the exhaust pipe and that holds a catalyst.

According to this configuration, the catalyst holder 50 is provided in the position, which corresponds to the lower side of the cylinder head 20, of the upper exhaust pipe 31 and the lower exhaust pipe 32, and the catalyst 53 is arranged in the exhaust openings 30 that have a relatively high temperature, so that the catalytic efficiency can be improved. Further, in the case of the V-type engine 10, since the site where the catalyst is arranged is the unused site, the arrangement of the lower exhaust pipe 32 on the downstream side of catalyst can be performed without waste, and the V-type engine 10 can be reduced in size and weight as a whole.

(Configuration 2) The V-type engine according to Configuration 1, wherein the catalyst holder is provided on a lower side of the exhaust opening positioned at a lowest of the exhaust openings.

According to this configuration, since the catalyst holder is provided on the lower side of the exhaust opening positioned at the lowest of the exhaust openings, the arrangement of the exhaust pipe is easily performed and the center of gravity can be lowered.

(Configuration 3) The V-type engine according to Configuration 2, wherein the exhaust pipe includes an upper side folded-back portion formed in an upward curve on a downstream side of the catalyst and a lower side folded-back portion formed in a curve downward from the upper side folded-back portion.

According to this configuration, even when water enters from the exhaust pipe, delivery of the water from the lower side folded-back portion to a catalyst side can be restricted and the water does not reach the catalyst holder, so that a waterproof measure can be sufficiently taken.

(Configuration 4) The V-type engine according to Configuration 3, wherein the lower side folded-back portion is positioned above the catalyst holder.

According to this configuration, since the lower side folded-back portion is positioned above the catalyst holder, even when water enters from the exhaust pipe, delivery of the water from the lower side folded-back portion to the catalyst side can be restricted and the water does not reach the catalyst holder, so that the waterproof measure can be sufficiently taken.

(Configuration 5) The V-type engine according to Configuration 3, wherein the exhaust pipe on a downstream side of the lower side folded-back portion is connected to an exhaust passage of a casing.

According to this configuration, the exhaust gas passing the catalyst via the exhaust pipe can be discharged to the outside via the exhaust passage.

(Configuration 6) The V-type engine according to Configuration 1, wherein cooling water piping where part of cooling water to be delivered to the cylinder head is delivered is connected to the catalyst holder.

According to this configuration, by supplying the cooling water to the catalyst holder via the cooling water piping, the temperature of the catalyst holder can be adjusted to a predetermined temperature. Therefore, by maintaining the catalyst at a predetermined temperature, oxidation and reduction reaction of the catalyst can be favorably performed.

(Configuration 7) The V-type engine according to Configuration 6, wherein the catalyst holder is directly attached to the cylinder head.

According to this configuration, the catalyst holder can be easily installed in the cylinder head.

(Configuration 8) The V-type engine according to Configuration 6, wherein the catalyst holder is attached to the cylinder head via an attaching jig.

According to this configuration, the catalyst holder can be easily installed in the cylinder head using the attaching jig.

(Configuration 9) An outboard motor including the V-type engine according to any one of Configurations 1 to 8.

According to this configuration, an outboard motor can be obtained in which even in a case where a catalyst is installed, the arrangement of the exhaust pipe is easily performed and the center of gravity can be lowered.

(Configuration 10) A watercraft including the outboard motor according to Configuration 9.

According to this configuration, a watercraft can be obtained that uses the outboard motor in which even in a case where a catalyst is installed, the arrangement of the exhaust pipe is easily performed and the center of gravity can be lowered.

### REFERENCE SIGNS LIST

1 outboard motor
2 casing
10 V-type engine
11 crank chamber
12 crankcase
13 crankshaft
14 cylinder block
15 cylinder
16 piston
17 connecting rod
18 drive sprocket
20 cylinder head
21 combustion chamber
22 intake valve
23 intake port
24 exhaust valve
25 exhaust port
26 camshaft
27 cam
28 cam sprocket
29 timing belt
30 exhaust opening
31 upper exhaust pipe
32 lower exhaust pipe
33 upper side folded-back portion
34 lower side folded-back portion
50 catalyst holder
51 inner tube
52 outer tube
53 catalyst
54 cooling water piping
55 gasket
57 attaching jig

1. A V-type engine in which cylinders where pistons operate are arranged in a V-shape and a crankshaft driven by driving of the pistons is disposed vertically, the V-type engine comprising:
exhaust pipes communicating with exhaust openings in respective banks of a cylinder head; and
a catalyst holder that is provided in a position, which corresponds to a lower side of the cylinder head, of the exhaust pipe and that holds a catalyst.

2. The V-type engine according to claim 1, wherein the catalyst holder is provided on a lower side of the exhaust opening positioned at a lowest of the exhaust openings.

3. The V-type engine according to claim 1, wherein the exhaust pipe comprises an upper side folded-back portion formed in an upward curve on a downstream side of the catalyst and a lower side folded-back portion formed in a curve downward from the upper side folded-back portion.

4. The V-type engine according to claim 3, wherein the lower side folded-back portion is positioned above the catalyst holder.

5. The V-type engine according to claim 3, wherein the exhaust pipe on a downstream side of the lower side folded-back portion is connected to an exhaust passage of a casing.

6. The V-type engine according to claim 1, wherein cooling water piping where part of cooling water to be delivered to the cylinder head is delivered is connected to the catalyst holder.

7. The V-type engine according to claim 6, wherein the catalyst holder is directly attached to the cylinder head.

8. The V-type engine according to claim 6, wherein the catalyst holder is attached to the cylinder head via an attaching jig.

9. An outboard motor, comprising the V-type engine according to claim 1.

10. A watercraft, comprising the outboard motor according to claim 9.
